(19) United States
(12) Patent Application Publication
(10) Pub. No.: US 2024/0212257 A1
(43) Pub. Date: Jun. 27, 2024

(54) WORKLOAD PACKING IN GRAPHICS TEXTURE PIPELINE

(71) Applicant: QUALCOMM Incorporated, San Diego, CA (US)

(72) Inventors: Liang LI, San Diego, CA (US); Andrew Evan GRUBER, Arlington, MA (US); Baoguang YANG, Fremont, CA (US)

(21) Appl. No.: 18/145,804

(22) Filed: Dec. 22, 2022

(51) Int. Cl. G06T 15/04; G06T 1/20; G06T 15/00

(52) U.S. Cl. CPC G06T 15/04; G06T 1/20; G06T 15/005

(57) ABSTRACT

This disclosure provides systems, devices, apparatus, and methods, including computer programs encoded on storage media, for workload packing in a graphics texture pipeline. A graphics processor may combine a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component. The graphics processor may process, in a texture pipeline at the graphics processor, the one or more hardware transactions including the set of samples. The graphics processor may output an indication of the processed one or more hardware transactions including the set of samples.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques related to graphics processing may not fully and/or efficiently utilize hardware logic in a texture pipeline. There is a need for improved techniques for increasing utilization of hardware logic in texture pipelines.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and at least one processor coupled to the memory and, based at least in part on information stored in the memory, the at least one processor is configured to: combine a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component; process, in a texture pipeline at a graphics processor, the one or more hardware transactions including the set of samples; and output an indication of the processed one or more hardware transactions including the set of samples.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a GPU) in accordance with one or more techniques of this disclosure.

FIG. 3 illustrates an example image or surface in accordance with one or more techniques of this disclosure.

FIG. 4 is a diagram illustrating example aspects of a texture pixel (i.e., a texel) in accordance with one or more techniques of this disclosure.

FIG. 5 is a diagram illustrating example aspects of texture filtering including point filtering and bilinear filtering in accordance with one or more techniques of this disclosure.

FIG. 6 is a diagram illustrating example aspects of texture filtering including trilinear filtering in accordance with one or more techniques of this disclosure.

FIG. 7 is a diagram illustrating example aspects of a graphics pipeline and a compute pipeline in accordance with one or more techniques of this disclosure.

FIG. 8 is a diagram illustrating example aspects of a texture pipeline in accordance with one or more techniques of this disclosure.

FIG. 9 is a diagram illustrating example aspects of a texture pipeline with packing check and control in accordance with one or more techniques of this disclosure.

FIG. 10 is a call flow diagram illustrating example communications between a graphics processor and a graphics processor component in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

A graphics processor (e.g., a GPU or another device) (may execute various hardware transactions in a texture pipeline in order to facilitate the presentation of graphical content on a display. The texture pipeline may support different sampling and filtering operations on different texture data formats. The different sampling and filtering operations on the different texture data formats may lead to hardware logic for certain hardware transactions being underutilized. For example, the texture pipeline may include hardware logic for a first texel, hardware logic for a second texel, hardware logic for a third texel, and hardware logic for a fourth texel, but a hardware transaction may utilize the hardware logic for the first texel without utilizing the hardware logic for the second texel, hardware logic for the third texel, and hardware logic for the fourth texel. Underutilization of hardware logic may lead to increased power consumption and/or may introduce inefficiencies into the texture pipeline.

Various technologies pertaining to workload packing in a graphics texture pipeline are described herein. In an example, an apparatus combines a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component. The apparatus processes, in a texture pipeline at a graphics processor, the one or more hardware transactions including the set of samples. The apparatus outputs an indication of the processed one or more hardware transactions including the set of samples. Vis-à-vis combining (i.e., packing) the set of samples into the one or more hardware transactions, the apparatus (e.g., a graphics processor) may facilitate efficient usage of hardware logic for the hardware transactions. Stated differently, the combining may increase a throughput associated with the texture pipeline while a size of a data path associated with the one or more hardware transactions may remain constant. The combining may increase usage of previously unused hardware logic in the graphics texture pipeline. This may lead to reduced power consumption for the apparatus and faster application of textures to shapes associated with graphical content.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

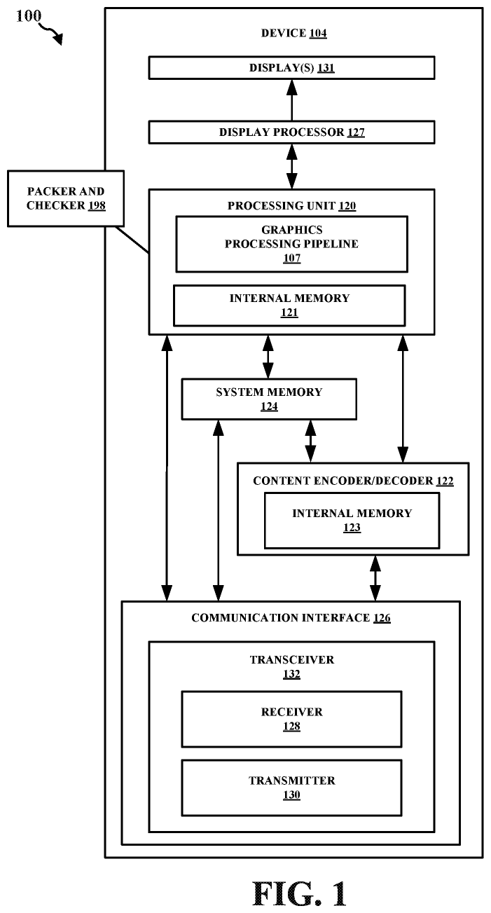

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a packer and checker 198 configured to combine a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component; process, in a texture pipeline at a graphics processor, the one or more hardware transactions including the set of samples; and output an indication of the processed one or more hardware transactions including the set of samples. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

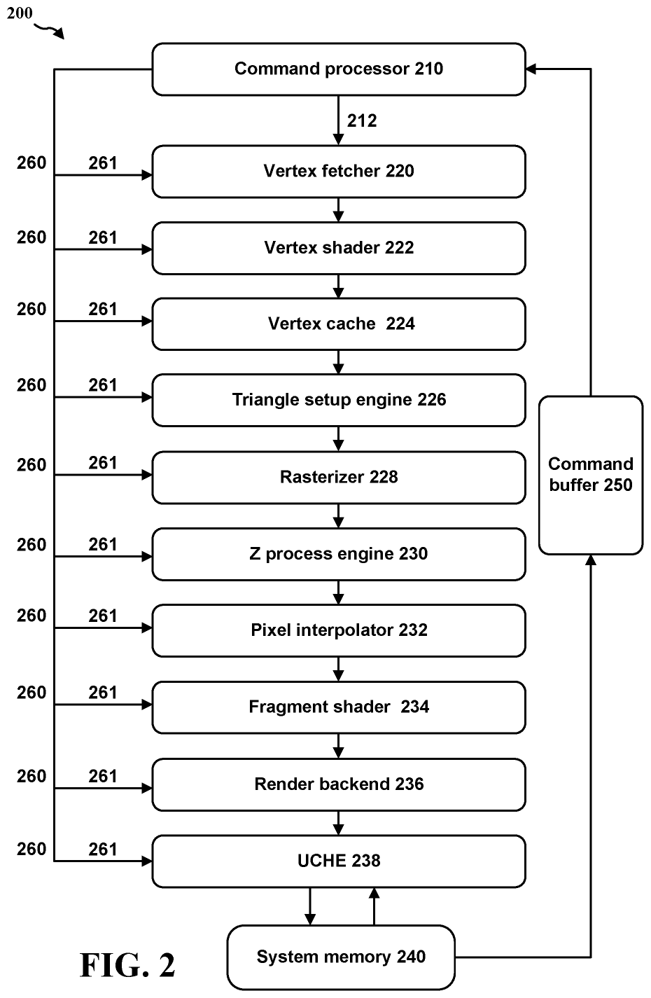

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

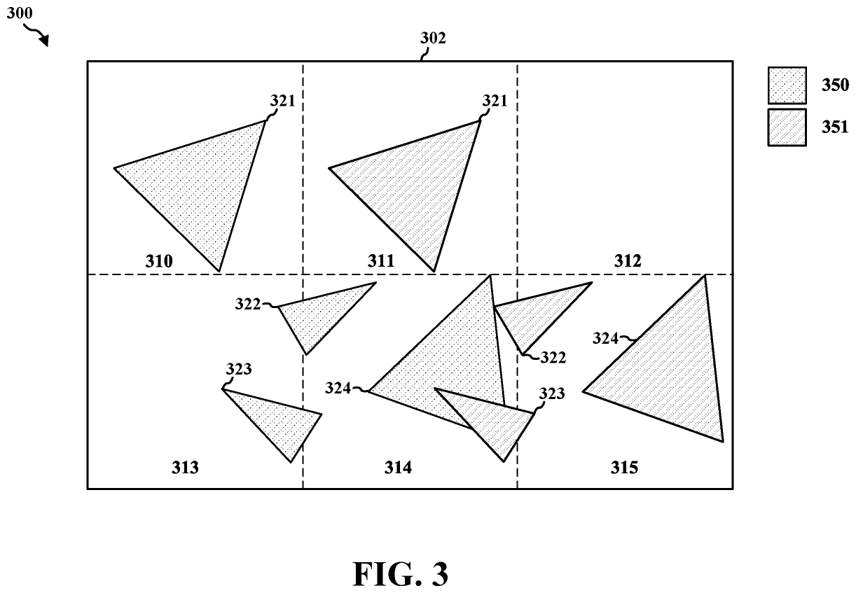

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

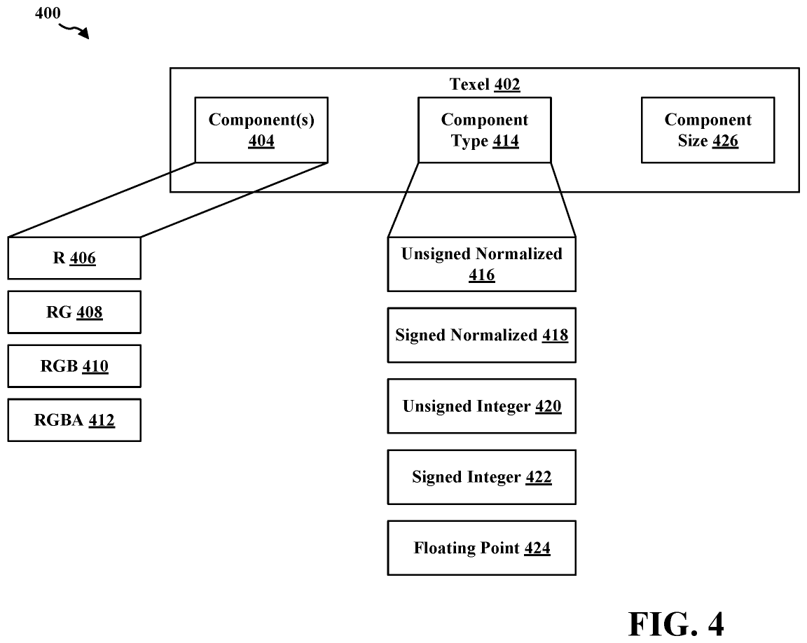

FIG. 4 is a diagram 400 illustrating example aspects of a texel 402. The texel 402 may be a fundamental unit of a texture map. A texture map may be an image that includes texels (e.g., the texel 402, as well as additional texels that may be the same as the texel 402 or different from the texel 402) that is applied (i.e., mapped) to a surface of a shape, polygon, or three-dimensional (3D) model in order to add color and/or detail to the surface of the shape, the polygon, or the 3D model. The texture map may also be referred to as a texture. A GPU may perform texture mapping in order to map texel(s) to appropriate pixels in a geometric fragment (e.g., a triangle) in an output image. Texture mapping may involve sampling the texture map (i.e., “texture sampling”) for one or more texels (e.g., the texel 402). Texture mapping may enable the GPU to simulate near-photorealism in real-time. In an example, a texture map may represent “bricks” and the GPU may perform texture mapping with respect to a rectangle in order to make a resultant image appear as a brick wall. The texel 402 may also be referred to as a texture element or a texture pixel.

The texel 402 may include component(s) 404. In one example, the texel 402 may include a red component (R 406). In another example, the texel 402 may include a red component and a green (G) component (RG 408). In yet another example, the texel 402 may include a red component, a green component, and a blue (B) component (RGB 410). In a further example, the texel 402 may include a red component, a green component, a blue component, and an alpha (A) component (RGBA 412). Other configurations of the component(s) 404 may be possible (e.g., RB, G, etc.). Additionally, in some aspects, the texel 402 may include more than four components. In an example, the texel 402 may include RGBA 412. A shader may request one or more components (e.g., a R component) for the texel 402 and packing (explained in greater detail below) may be based on the requested one or more components (e.g., the R component).

Each of the component(s) 404 of the texel 402 may be associated with a value having a type (i.e., a component type 414). The component type 414 may be unsigned normalized 416. In unsigned normalized 416, each of the component(s) 404 may be stored as a floating-point value in the range of [0, 1]. The component type 414 may be signed normalized 418. In signed normalized 418, each of the component(s) 404 may be stored as a floating-point value in the range of [−1, 1]. The component type 414 may be unsigned integer 420. In unsigned integer 420, each of the component(s) 404 may be stored as an unsigned integer. The component type 414 may be signed integer 422. In signed integer 422, each of the component(s) 404 may be stored as a signed integer, where the signed integer may be a 2's complement integer value. The component type 414 may be floating point 424. In floating point 424, each of the component(s) 404 may be stored as a floating point number.

Each of the component(s) 404 of the texel 402 may have an associated size (i.e., a component size 426) in bits. In an example, the component size 426 may be 2 bits, 4 bits, 5 bits, 8 bits, 10 bits, 12 bits, 16 bits, or 32 bits. In some aspects, the component(s) 404 and/or the component type 414 of the texel 402 may control the component size 426 of the texel 402. The component size 426 may also be referred to as a bitdepth.

In one example, the texel 402 may include a R component that includes 8 bits that represent a signed integer. In another example, the texel 402 may include a R component and a G component that each include 16 bits that each represent an unsigned integer. In yet another example, the texel 402 may include a R component, a G component, a B component, and an A component that each include 32 bits that each represent a floating point number.

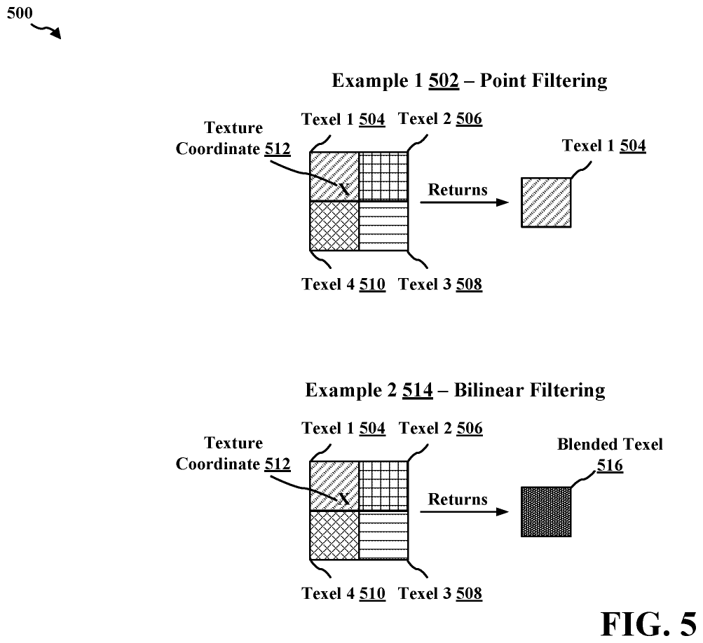

FIG. 5 is a diagram 500 illustrating example aspects of texture filtering including point filtering and bilinear filtering. Texture filtering may refer to a technique performed by a GPU (or another device) that is used to determine a texture color for a texture mapped pixel using colors of nearby texels (e.g., the texel 402), and optionally other information. Texture filtering may describe how a texture is applied at different shapes, sizes, angles, and scales. In an example, a GPU (or another device) may perform texture sampling to retrieve one or more texels from a texture map and the GPU may perform texture filtering on the one or more texels in order to produce a result of the texture sampling, where the result may be a combination of components of the one or more texels.

A GPU (or another device) may perform a texture mapping process for a two-dimensional (2D) or 3D surface in order to determine where each pixel center falls on a texture. In an example, each pixel may be associated with one or more primitives (e.g., triangles) and a set of barycentric coordinates that are used to provide a position within a texture. Texture filtering may be employed to account for scenarios in which a position does not align exactly on a pixel grid. For instance, a textured surface may be at an arbitrary distance and orientation relative to a viewer, and as a result, one pixel may not correspond to one texel. In one example, a viewer may be at a viewing distance where one pixel is the same as one texel. In another example, the viewer may be at a viewing distance where a texel is larger than a pixel, and hence the texel may be scaled up (i.e., “texture magnification”). In yet another example, the viewer may be at a viewing distance where a texel is smaller than a pixel such that one pixel may cover more than one texel, and hence a color may be selected based on the more than one texel (i.e., “texture minification”). Even if the viewer is at a viewing distance where one pixel is the same as one texel, a pixel may not match up exactly to one texel (e.g., the pixel may be misaligned, rotated, and/or may cover parts of neighboring texels) and hence texture filtering may still be utilized. Texture filtering may reduce artifacts and/or “blurriness” in a displayed image.

In a first example 502, a GPU (or another device) may perform point filtering (i.e., a type of texture filtering). Point filtering may also be referred to as nearest neighbor point filtering. In point filtering, the GPU may select a texel having a center closest to a texture coordinate and output the selected texel. For instance, in the first example 502, the GPU may sample a first texel 504, a second texel 506, a third texel 508, and a fourth texel 510 (i.e., the GPU may perform point sampling) based on a texture coordinate 512 (indicated by an “X” in the first example 502) obtained by the GPU. Stated differently, the GPU may sample neighboring texels (e.g., four texels) of the texture coordinate 512. In an example, the first texel 504 may be the texel 402. The GPU may select and output the first texel 504 as the first texel 504 has a center that is closest to the texture coordinate 512 in comparison to centers of the second texel 506, the third texel 508, and the fourth texel 510. Alternatively, the GPU may also sample the first texel 504 based on the texture coordinate 512 without sampling the second texel 506, the third texel 508, and the fourth texel 510.

In a second example 514, a GPU (or another device) may perform bilinear filtering (i.e., a type of texture filtering). In bilinear filtering, the GPU may sample neighboring texels (e.g., four texels) of the texture coordinate 512. For instance, the GPU may sample the first texel 504, the second texel 506, the third texel 508, and the fourth texel 510 (i.e., the GPU may perform bilinear sampling) based on the texture coordinate 512. The GPU may calculate an interpolated value from each of the first texel 504, the second texel 506, the third texel 508, and the fourth texel 510 and output a blended texel 516. In an example, the interpolated value may be based upon the component(s) 404, the component type 414, and the component size 426 of the texel 402 (as well as corresponding contributions from the second texel 506, the third texel 508, and the fourth texel 510).

An amount of contribution of each of the first texel 504, the second texel 506, the third texel 508, and the fourth texel 510 to the interpolated value of the blended texel 516 may be based on a distance of the texture coordinate from each of the centers of the first texel 504, the second texel 506, the third texel 508, and the fourth texel 510. In an example, the first texel 504 may contribute a relatively greater amount to the blended texel 516 as a center of the first texel 504 is relatively close to the texture coordinate 512 and the third texel 508 may contribute a relatively lesser amount to the blended texel 516 as a center of the third texel 508 is relatively far away from the texture coordinate 512. In an example, calculating the interpolated value of the blended texel 516 may involve computing a weighted average (or some other representative value) of components of each of the first texel 504, the second texel 506, the third texel 508, and the fourth texel 510. In comparison to point filtering, bilinear filtering may be associated with reduced aliasing and shimmering; however, bilinear filtering may utilize greater processing power in comparison to point filtering.

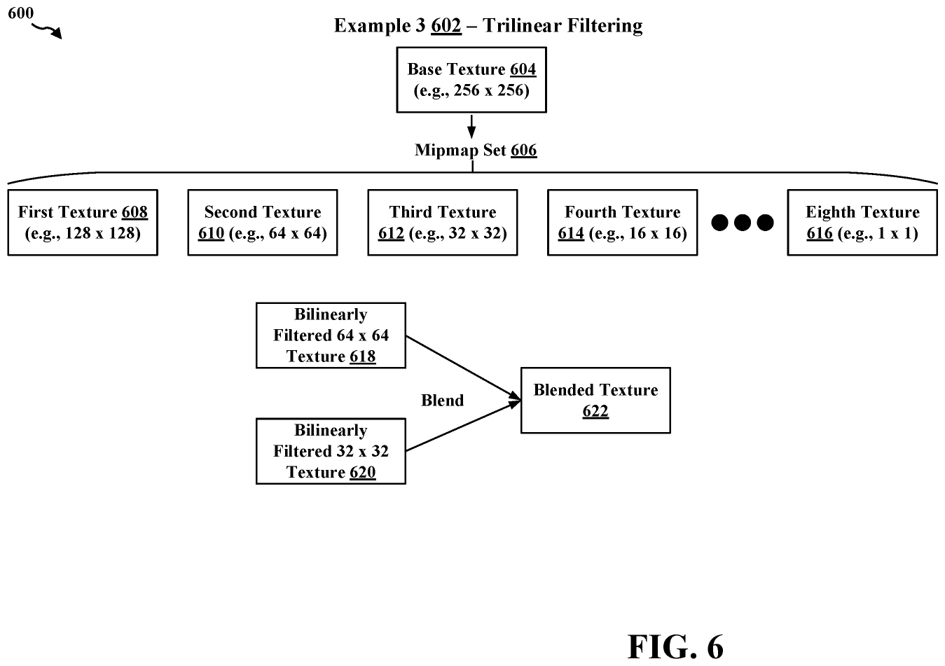

FIG. 6 is a diagram 600 illustrating example aspects of texture filtering including trilinear filtering. Trilinear filtering may refer to texture filtering in which a texture lookup is performed, bilinear filtering (e.g., as illustrated in the second example 514) is applied to two closest mipmap levels (explained in greater detail below), and a linear interpolation is performed on the bilinearly filtered mipmap levels. A mipmap may also be referred to as a MIP map or pyramids and may refer to a calculated (e.g., pre-calculated) optimized sequence of images, each of which may be a progressively lower resolution representation of a previous image.

In a third example 602, a GPU (or another device) may perform trilinear filtering. The GPU may obtain a 256×256 base texture 604 (i.e., a 256×256 pixel texture). In an example, the 256×256 base texture 604 may include the texel 402. The GPU may compute and/or obtain a mipmap set 606 based on the 256×256 base texture 604. The GPU may also obtain a texture coordinate (e.g., the texture coordinate 512, not shown in FIG. 6). The mipmap set 606 may include a plurality of images, where each of the plurality of images is a downscaled duplicate of the 256×256 base texture 604. In an example, the mipmap set 606 may include a 128×128 first texture 608, a 64×64 second texture 610, a 32×32 third texture 612, a 16×16 fourth texture 614, an 8×8 fifth texture (not depicted in FIG. 6), a 4×4 sixth texture (not depicted in FIG. 6), a 2×2 seventh texture (not depicted in FIG. 6), and a 1×1 eighth texture 616. In an example, the 128×128 first texture 608 may include a reduced level of detail in comparison to the 256×256 base texture 604, the 64×64 second texture 610 may include a reduced level of detail in comparison to the 128×128 first texture 608, and so forth.

The GPU may obtain an indication of a space of pixels in which a scene is to be rendered. In an example, the space of pixels may be 40×40 pixels. The GPU may select a first texture in the mipmap set 606 that is closest to and greater than the space of pixels (40×40 pixels) and a second texture in the mipmap set 606 that is closest to and less than the space of pixels (40×40 pixels). For instance, the GPU may select the 64×64 second texture 610 as a first texture for filtering and the 32×32 third texture 612 as a second texture for filtering. The GPU may perform bilinear filtering (e.g., as described in the second example 514) on the 64×64 second texture 610 and the 32×32 third texture 612 to obtain a bilinearly filtered 64×64 texture 618 and a bilinearly filtered 32×32 texture 620, respectively. The GPU may scale the texture coordinate in order to perform the bilinear filtering on the 64×64 second texture 610 and the GPU may scale the texture coordinate in order to perform the bilinear filtering on the 32×32 third texture 612. The GPU may blend (i.e., linearly interpolate) the bilinearly filtered 64×64 texture 618 and the bilinearly filtered 32×32 texture 620 to obtain a blended texture 622. In comparison to bilinear filtering, trilinear filtering may be associated with a smoother degradation of texture quality as a distance from a viewer decreases.

Although FIGS. 5 and 6 depict examples of point filtering, bilinear filtering, and trilinear filtering, a GPU (or another device) may perform other types of texture filtering in place of or in addition to point filtering, bilinear filtering, and trilinear filtering. The other types of texture filtering may include anisotropic filtering, nearest neighbor with mipmapping filtering, linear mipmap filtering, and percentage closer filtering.

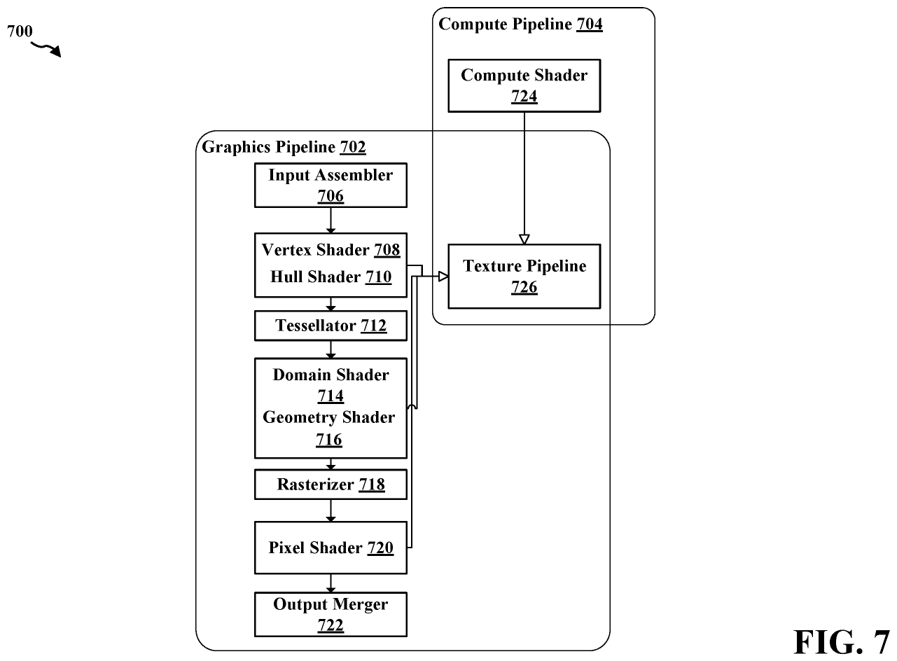

FIG. 7 is a diagram 700 illustrating example aspects of a graphics pipeline 702 and a compute pipeline 704. In an example, the graphics pipeline 702 and the compute pipeline 704 may be associated with a GPU (e.g., the GPU 200) of a device (e.g., the device 104). The graphics pipeline 702 may be configured to process graphical data. The compute pipeline 704 may be configured to process arbitrary data (e.g., graphical data and non-graphical data). As used herein, the term “arbitrary data” may refer to “various types of data,” “generic data,” or “general data.” The graphics pipeline 702 and the compute pipeline 704 may work in conjunction with one another to facilitate the presentation of graphical data on a display or displays (e.g., the display(s) 131).

The graphics pipeline 702 may include an input assembler 706. The input assembler 706 may read primitive data (e.g., points, lines, and/or triangles) from buffers and assemble the data into primitives (e.g., triangles) that may be used in subsequent stages of the graphics pipeline 702. The input assembler 706 may assemble vertices into different primitive types, such as line lists, triangle strips, or primitives with adjacency. The input assembler 706 may attach system-generated values that are configured to increase efficiency of shaders (e.g., vertex shaders, geometry shaders, pixel shaders, etc.).

The graphics pipeline 702 may include a vertex shader 708 and/or a hull shader 710. The vertex shader 708 may receive, as input, vertices output from the input assembler 706, where the vertices may include the system-generated values. The vertex shader 708 may perform individual per-vertex processing on the vertices (which may include the system-generated values) that are output from the input assembler 706, such as transformations, skinning, morphing, and per-vertex lighting. The hull shader 710 may also break up a single surface of a model into many triangles. The hull shader 710 may produce a geometry patch and patch constants that correspond to each input patch (e.g., a quad, a triangle, or a line). The hull shader 710 may transform input control points that define a low-order surface into control points that make up a patch. The hull shader 710 may declare a state used in a tessellation stage. The state may include a number of control points, a type of patch face, and a type of partitioning to use for tessellation. The hull shader 710 may output control points (for consumption in a domain-shader stage) and patch constant state (for consumption in a domain shader stage).

The graphics pipeline 702 may include a tessellator 712. The tessellator 712 may receive an output from the vertex shader 708 and/or the hull shader 710. The tessellator 712 may create a sampling pattern of a domain that represents a geometry patch. The tessellator 712 may generate a set of smaller objects (e.g., triangles, points, lines) that connect samples associated with the sampling pattern. The tessellator 712 may operate on a patch based on tessellation factors that specify a degree to which a domain is to be tessellated and based on a type of partitioning (passed from the hull shader 710) that specifies how the patch is to be sliced. The tessellator 712 may output uv (and optionally w) coordinates and a surface topology for a domain shader stage.

The graphics pipeline 702 may include a domain shader 714 and/or a geometry shader 716. The domain shader 714 may calculate vertex positions of subdivided points in an output patch based on input from the hull shader 710 and the tessellator 712. The geometry shader 716 may process entire primitives, such as triangles, lines, points, and adjacent vertices associated with primitives. The geometry shader 716 may output multiple vertices that form a single selected topology, such as a tristrip, a linestrip, or a pointlist.

The graphics pipeline 702 may include a rasterizer 718. The rasterizer 718 may clip primitives that are not in view, prepare primitives for a pixel shader stage, and determine how to invoke pixel shaders. The rasterizer 718 may convert vector information (composed of shapes or primitives) into a raster image (composed of pixels) in order to display real-time 3D graphics. The rasterizer 718 may receive input from the vertex shader 708, the domain shader 714, and/or the geometry shader 716.

The graphics pipeline 702 may include a pixel shader 720. The pixel shader 720 may receive interpolated data for a primitive (e.g., from the rasterizer 718 or another component of the graphics pipeline 702) and generate per-pixel data such as color. The graphics pipeline 702 may include an output merger 722. The output merger 722 may combine various types of output data (e.g., pixel shader values, etc.) with contents of a render target and various buffers to generate an output pipeline result that may be used to display graphical data.

The compute pipeline 704 may include a compute shader 724. The compute shader 724 may be configured to process arbitrary data (e.g., graphical data, non-graphical data, etc.). The compute shader 724 may be utilized for tasks that are not directly related to drawing triangles and pixels.

The graphics pipeline 702 may include a texture pipeline 726. The texture pipeline 726 may be configured to apply textures to shapes, objects, etc. For instance, the texture pipeline 726 may be configured to perform texture mapping. The texture pipeline may also be considered to be part of the compute pipeline 704. The texture pipeline 726 may receive input from the compute shader 724, the vertex shader 708, the hull shader 710, the domain shader 714, the geometry shader 716, and/or the pixel shader 720. The texture pipeline 726 may output data to the pixel shader 720. The texture pipeline 726 is described in greater detail below.

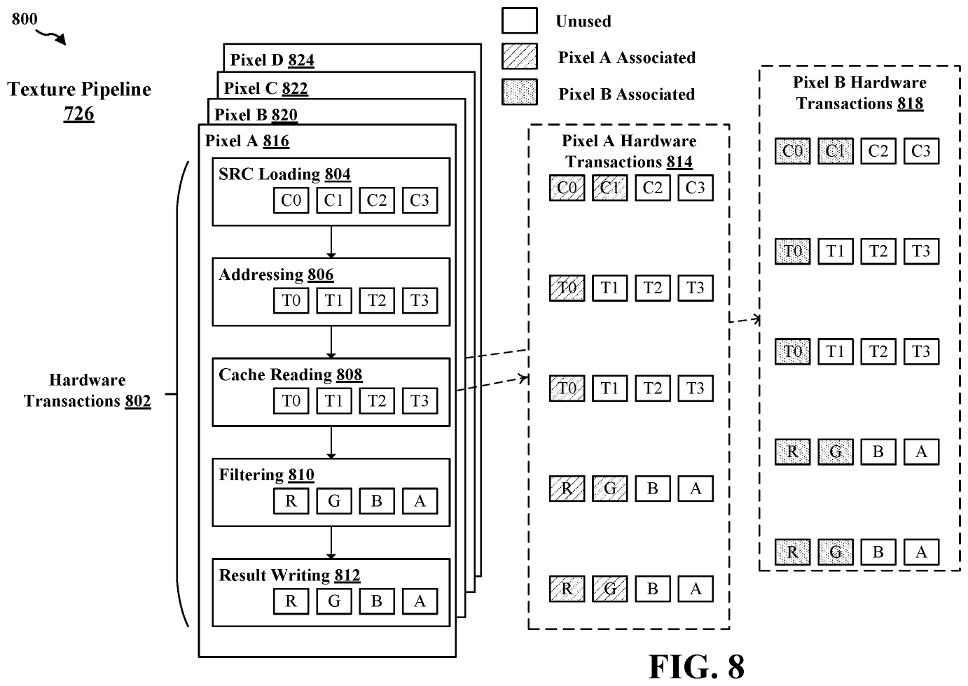

FIG. 8 is a diagram 800 illustrating example aspects of the texture pipeline 726. The texture pipeline 726 may include hardware transactions 802 that, when executed by a GPU (or another device), facilitate or cause textures to be applied to shapes, objects, etc. Although the texture pipeline 726 is depicted in the diagram 800 as supporting a four component texture (e.g., RGBA), performing point sampling/filtering, and writing a two component texture (e.g., a RG texture), the texture pipeline 726 may also be configured for other types of textures (e.g., a RG texture, a RGB texture, etc.) and/or other types of sampling/filtering (e.g., bilinear sampling/filtering, trilinear sampling/filtering, anisotropic sampling/filtering, etc.).

The hardware transactions 802 may include source loading (i.e., SRC loading 804). During the SRC loading 804, the texture pipeline 726 may receive a request from a shader (e.g., the vertex shader 708, the hull shader 710, etc.), where the requests includes SRC parameters and sample command related information. In the example depicted in the diagram 800, the SRC loading 804 may be associated with hardware logic for four coordinates (C0, C1, C2, and C3), that is, the SRC loading 804 may be associated with first hardware logic for C0, second hardware logic for C1, third hardware logic for C2, and fourth hardware logic for C3, where each hardware logic is represented in the diagram 800 by a box (e.g., a box including C0, a box including C1, a box including C2, and a box including C3).

The hardware transactions 802 may include addressing 806. During the addressing 806, the texture pipeline 726 may generate addresses for sample texels (e.g., the texel 402) for pixels according to the sample command related information and a sample mode (e.g., point sampling, bilinear sampling, trilinear sampling, anisotropic sampling, etc.). In the example depicted in the diagram 800, the addressing 806 may be associated with hardware logic for four texels (T0, T1, T2, and T3), that is, the addressing 806 may be associated with first hardware logic for T0, second hardware logic for T1, third hardware logic for T2, and fourth hardware logic for T3, where each hardware logic is represented in the diagram 800 by a box (e.g., a box including T0, a box including T1, a box including T2, and a box including T3).

The hardware transactions 802 may include cache reading 808. During the cache reading 808, the texture pipeline 726 may read from texels (e.g., the texel 402) stored in a cache. For instance, the cache may store a texture that includes the texels, and the texture pipeline 726 may read the texels from the texture in the cache during the cache reading 808. In the example depicted in the diagram 800, the cache reading 808 may be associated with hardware logic for four texels (T0, T1, T2, and T3), that is, the cache reading 808 may be associated with first hardware logic for T0, second hardware logic for T1, third hardware logic for T2, and fourth hardware logic for T3, where each hardware logic is represented in the diagram 800 by a box (e.g., a box including T0, a box including T1, a box including T2, and a box including T3). The hardware logic for the addressing 806 may be different from the hardware logic for the cache reading 808.

The hardware transactions 802 may include filtering 810. During the filtering 810, the texture pipeline 726 may perform texture filtering (e.g., point filtering, bilinear filtering, trilinear filtering, anisotropic filtering, etc.) for pixels. Performing the filtering 810 may involve computing a weighted sum of each sample associated with a component. In an example, the texture pipeline 726 may compute a weighted sum for a R component of four samples. In the example depicted in the diagram 800, the filtering 810 may be associated with hardware logic for four channels (R, G, B, and A), that is, the filtering 810 may be associated with first hardware logic for R, second hardware logic for G, third hardware logic for B, and fourth hardware logic for A, where each hardware logic is represented in the diagram 800 by a box (e.g., a box including R, a box including G, a box including B, and a box including A). In an example, the R channel, the G channel, the B channel, and the A channel may respectively correspond to a R component, a G component, a B component, and an A component of a texel.

The hardware transactions 802 may include result writing 812. During the result writing 812, the texture pipeline 726 may write a texture result back to a shader (e.g., the pixel shader 720) and return sample requested components indicated by the request received during the SRC loading 804. In the example depicted in the diagram 800, the result writing 812 may be associated with hardware logic for four channels (R, G, B, and A), that is, the result writing 812 may be associated with first hardware logic for R, second hardware logic for G, third hardware logic for B, and fourth hardware logic for A, where each hardware logic is represented in the diagram 800 by a box (e.g., a box including R, a box including G, a box including B, and a box including A). In an example, the R channel, the G channel, the B channel, and the A channel may respectively correspond to a R component, a G component, a B component, and an A component of a texel. The hardware logic for the filtering 810 may be different from the hardware logic for the result writing 812.

The diagram 800 depicts pixel hardware transactions (e.g., pixel A hardware transactions 814 for pixel A 816 and pixel B hardware transactions 818 for pixel B 820). The texture pipeline 726 may perform the pixel A hardware transactions 814, the pixel B hardware transactions 818, pixel C hardware transactions (not illustrated in the diagram 800) for pixel C 822, and pixel D hardware transactions (not illustrated in the diagram 800) for pixel D 824 in parallel. In an example, pixel A 816, pixel B 820, pixel C 822, and pixel D 824 may be associated with graphical content that is to be presented on a display (e.g., the display(s) 131).

As illustrated in the pixel A hardware transactions 814 for pixel A 816, during the SRC loading 804, the texture pipeline 726 may load a first coordinate into hardware logic for C0 and a second coordinate into hardware logic for C1. The hardware logic for C2 and C3 may go unused. During the addressing 806, the texture pipeline 726 may address a texel using hardware logic for T0. In the example, the addressing 806 may correspond to point sampling. The hardware logic for T1, T2, and T3 may go unused. During the cache reading 808, the texture pipeline 726 may load the texel into hardware logic associated with T0. In the example, the addressing 806 and the cache reading 808 for the pixel A hardware transactions 814 may be associated with point sampling. During the filtering 810, the texture pipeline 726 may perform texture filtering using hardware logic for the R channel and hardware logic for the G channel. In the example, the filtering 810 may include point filtering. The hardware logic for the B channel and the hardware logic for the A channel may go unused. During the result writing 812, the texture pipeline 726 may write a texture to a pixel shader (or another shader) using hardware logic for the R channel and hardware logic for the G channel. The hardware logic for the B channel and the hardware logic for the A channel may go unused.

Similarly, as illustrated in the pixel B hardware transactions 818 for pixel B 820, during the SRC loading 804, the texture pipeline 726 may load a first coordinate into hardware logic for C0 and a second coordinate into hardware logic for C1. The hardware logic for C2 and C3 may go unused. During the addressing 806, the texture pipeline 726 may address a texel using hardware logic for T0. In the example, the addressing 806 may correspond to point sampling. The hardware logic for T1, T2, and T3 may go unused. During the cache reading 808, the texture pipeline 726 may load the texel into hardware logic associated with T0. In the example, the addressing 806 and the cache reading 808 for the pixel A hardware transactions 814 may be associated with point sampling. During the filtering 810, the texture pipeline 726 may perform texture filtering using hardware logic for the R channel and hardware logic for the G channel. In the example, the filtering 810 may include point filtering. The hardware logic for the B channel and the hardware logic for the A channel may go unused. During the result writing 812, the texture pipeline 726 may write a texture to a pixel shader (or another shader) using hardware logic for the R channel and hardware logic for the G channel. The hardware logic for the B channel and the hardware logic for the A channel may go unused.

As illustrated in the diagram 800 and as described above with respect to the pixel A hardware transactions 814 and the pixel B hardware transactions 818, hardware logic for C2, C3, T1, T2, T3, the B channel, and the A channel may go unused as the texture pipeline 726 performs the SRC loading 804, the addressing 806, the cache reading 808, the filtering 810, and the result writing 812. For instance, texel generation stages may be under-utilized for point sampling, data loading/processing stages may be under-utilized for single component data, etc. This may lead to an inefficient use of the hardware logic and may lead to increased power consumption.

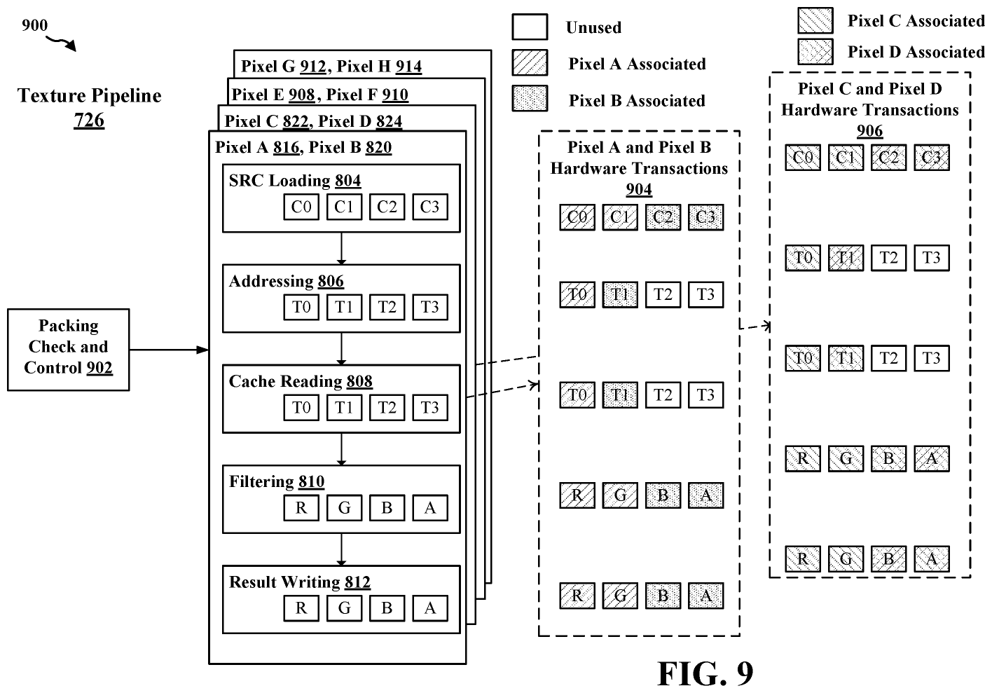

FIG. 9 is a diagram 900 illustrating example aspects of the texture pipeline 726 with packing check and control 902. In an example, the packing check and control 902 may be performed by the packer and checker 198. As will be described in greater detail below, the packing check and control 902 may obtain a higher throughput for the texture pipeline 726 while avoiding expanding a data path associated with the hardware transactions 802 by packing samples associated with different pixels into hardware logic of a single data path. For instance, the packing check and control 902 may pack the pixel A hardware transactions 814 for pixel A 816 and the pixel B hardware transactions 818 for pixel B 820 into pixel A and pixel B hardware transactions 904. Similarly, the packing check and control 902 may pack hardware transactions for pixel C 822 and hardware transactions for pixel D 824 into pixel C and pixel D hardware transactions 906. The packing check and control 902 may perform similar operations for pixel E 908 and pixel F 910, as well as pixel G 912 and pixel H 914.

In an example with respect to the pixel A and pixel B hardware transactions 904, the packing check and control 902 may determine that there are four instances of hardware logic (C0, C1, C2, and C3) available for the SRC loading 804. The packing check and control 902 may also determine that pixel A 816 and pixel B 820 are each associated with two respective coordinates. Based on the determination that there are four instances of hardware logic available for SRC loading 804 and the determination that pixel A 816 and pixel B 820 are each associated with two respective coordinates, the packing check and control 902 may load a first coordinate for pixel A 816 into hardware logic for C0 and a second coordinate for pixel A 816 into hardware logic for C1. For pixel B 820, the packing check and control 902 may load a first coordinate for pixel B 820 into hardware logic for C2 and a second coordinate for pixel B 820 into hardware logic for C3. Thus, in comparison to the SRC loading 804 depicted in the diagram 800, the packing check and control 902 may ensure that the hardware logic for the SRC loading 804 is more fully utilized.

The packing check and control 902 may determine that there are four instances of hardware logic (T0, T1, T2, and T3) available for the addressing 806. The packing check and control 902 may determine a sampling mode that is to be utilized based on data received from the graphics pipeline 702 and/or the compute pipeline 704. In an example, the sampling mode may be point sampling. Based on the determination that there are four instances of hardware logic (T0, T1, T2, and T3) available for the addressing 806 and the determination that the sampling mode is point sampling, the packing check and control 902 may address a first texel (e.g., the texel 402) for pixel A 816 using hardware logic for T0. Similarly, the packing check and control 902 may address a second texel for pixel B 820 using hardware logic for T1. Thus, in comparison to the addressing 806 depicted in the diagram 800, the packing check and control 902 may ensure that the hardware logic for the addressing 806 is more fully utilized.

The packing check and control 902 may determine that there are four instances of hardware logic (T0, T1, T2, and T3) available for the cache reading 808. The packing check and control 902 may determine the sampling mode that is to be utilized based on data received from the graphics pipeline 702 and/or the compute pipeline 704. In an example, the sampling mode may be point sampling. Based on the determination that there are four instances of hardware logic (T0, T1, T2, and T3) available for the cache reading 808 and the determination that the sampling mode is point sampling, the packing check and control 902 may read the first texel for pixel A 816 from the cache using hardware logic for T0 and the packing check and control may read the second texel for pixel B 820 using the hardware logic for T1. Thus, in comparison to the addressing 806 depicted in the diagram 800, the packing check and control 902 may ensure that the hardware logic for the cache reading 808 is more fully utilized.

The packing check and control 902 may determine that there are four instances of hardware logic (R, G, B, and A) available for the filtering 810. In an example, the filtering may be point filtering. The packing check and control 902 may also determine that the first texel associated with pixel A 816 and the second texel associated with pixel B 820 are two component textures (e.g., a first texture with RGBA components in which a shader fetches a R component and a G component to obtain a first RG texture and a second texture with RGBA components in which a shader fetches a R component and a G component to obtain a second RG texture). Based on the determination that there are four instances of hardware logic available for the filtering 810 and based on the determination that the first texel associated with pixel A 816 and the second texel associated with pixel B 820 are two component textures, the packing check and control 902 may perform texture filtering on an R component of the first texel using hardware logic for the R channel and the packing check and control 902 may perform texture filtering on a G component of the first texel using hardware logic for the G channel. Similarly, the packing check and control 902 may perform texture filtering on an R component of the second texel using hardware logic for the G channel and the packing check and control 902 may perform texture filtering on the G component of the second texel using hardware logic for the A channel. Thus, in comparison to the filtering 810 depicted in the diagram 800, the packing check and control 902 may ensure that the hardware logic for the filtering 810 is more fully utilized.

The packing check and control 902 may determine that there are four instances of hardware logic (R, G, B, and A) available for the result writing 812. The packing check and control 902 may also determine that the first texel associated with pixel A 816 and the second texel associated with pixel B 820 are two component textures (e.g., a first texture with RGBA components in which a shader fetches a R component and a G component to obtain a first RG texture and a second texture with RGBA components in which a shader fetches a R component and a G component to obtain a second RG texture). Based on the determination that there are four instances of hardware logic available for the result writing 812 and based on the determination that the first texel associated with pixel A 816 and the second texel associated with pixel B 820 are two component textures, the packing check and control 902 may write the R component of the first texel using hardware logic for the R channel and the packing check and control 902 may write the G component of the first texel using hardware logic for the G channel. The packing check and control 902 may write the R component of the second texel using hardware logic for the B channel and the packing check and control 902 may write the G component of the second texel using hardware logic for the A channel. In an example, the R component and the G component of each of the first texel and the second texel may be written to a pixel shader or a shader processor (SP) associated with the pixel shader. Thus, in comparison to the result writing 812 depicted in the diagram 800, the packing check and control 902 may ensure that the hardware logic for the result writing 812 is more fully utilized.

In an example with respect to the pixel C and pixel D hardware transactions 906, the packing check and control 902 may determine that there are four instances of hardware logic (C0, C1, C2, and C3) available for the SRC loading 804. The packing check and control 902 may also determine that pixel C 822 and pixel D 824 are each associated with two respective coordinates. Based on the determination that there are four instances of hardware logic available for SRC loading 804 and the determination that pixel C 822 and pixel D 824 are each associated with two respective coordinates, the packing check and control 902 may load a first coordinate for pixel C 822 into hardware logic for C0 and a second coordinate for pixel C 822 into hardware logic for C1. For pixel D 824, the packing check and control 902 may load a first coordinate for pixel D 824 into hardware logic for C2 and a second coordinate for pixel D 824 into hardware logic for C3. Thus, in comparison to the SRC loading 804 depicted in the diagram 800, the packing check and control 902 may ensure that the hardware logic for the SRC loading 804 is more fully utilized.

The packing check and control 902 may determine that there are four instances of hardware logic (T0, T1, T2, and T3) available for the addressing 806. The packing check and control 902 may determine a sampling mode that is to be utilized based on data received from the graphics pipeline 702 and/or the compute pipeline 704. In an example, the sampling mode may be point sampling. Based on the determination that there are four instances of hardware logic (T0, T1, T2, and T3) available for the addressing 806 and the determination that the sampling mode is point sampling, the packing check and control 902 may address a first texel (e.g., the texel 402) for pixel C 822 using hardware logic for T0. Similarly, the packing check and control 902 may address a second texel for pixel D 824 using hardware logic for T1. Thus, in comparison to the addressing 806 depicted in the diagram 800, the packing check and control 902 may ensure that the hardware logic for the addressing 806 is more fully utilized.

The packing check and control 902 may determine that there are four instances of hardware logic (T0, T1, T2, and T3) available for the cache reading 808. The packing check and control 902 may determine the sampling mode that is to be utilized based on data received from the graphics pipeline 702 and/or the compute pipeline 704. In an example, the sampling mode may be point sampling. Based on the determination that there are four instances of hardware logic (T0, T1, T2, and T3) available for the cache reading 808 and the determination that the sampling mode is point sampling, the packing check and control 902 may read the first texel for pixel C 822 from the cache using hardware logic for T0 and the packing check and control 902 may read the second texel for pixel D 824 using the hardware logic for T1. Thus, in comparison to the addressing 806 depicted in the diagram 800, the packing check and control 902 may ensure that the hardware logic for the cache reading 808 is more fully utilized.

The packing check and control 902 may determine that there are four instances of hardware logic (R, G, B, and A) available for the filtering 810. In an example, the filtering may be point filtering. The packing check and control 902 may also determine that the first texel associated with pixel C 822 and the second texel associated with pixel D 824 are two component textures (e.g., a first texture with RGBA components in which a shader fetches a R component and a G component to obtain a first RG texture and a second texture with RGBA components in which a shader fetches a R component and a G component to obtain a second RG texture). Based on the determination that there are four instances of hardware logic available for the filtering 810 and based on the determination that the first texel associated with pixel C 822 and the second texel associated with pixel D 824 are two component textures, the packing check and control 902 may perform texture filtering on an R component of the first texel using hardware logic for the R channel and the packing check and control 902 may perform texture filtering on a G component of the first texel using hardware logic for the G channel. Similarly, the packing check and control 902 may perform texture filtering on an R component of the second texel using hardware logic for the G channel and the packing check and control 902 may perform texture filtering on the G component of the second texel using hardware logic for the A channel. Thus, in comparison to the filtering 810 depicted in the diagram 800, the packing check and control 902 may ensure that the hardware logic for the filtering 810 is more fully utilized.

The packing check and control 902 may determine that there are four instances of hardware logic (R, G, B, and A) available for the result writing 812. The packing check and control 902 may also determine that the first texel associated with pixel C 822 and the second texel associated with pixel D 824 are two component textures (e.g., a first texture with RGBA components in which a shader fetches a R component and a G component to obtain a first RG texture and a second texture with RGBA components in which a shader fetches a R component and a G component to obtain a second RG texture). Based on the determination that there are four instances of hardware logic available for the result writing 812 and based on the determination that the first texel associated with pixel C 822 and the second texel associated with pixel D 824 are two component textures, the packing check and control 902 may write the R component of the first texel using hardware logic for the R channel and the packing check and control 902 may write the G component of the first texel using hardware logic for the G channel. The packing check and control 902 may write the R component of the second texel using hardware logic for the B channel and the packing check and control 902 may write the G component of the second texel using hardware logic for the A channel. In an example, the R component and the G component of each of the first texel and the second texel may be written to a pixel shader or a shader processor (SP) associated with the pixel shader. Thus, in comparison to the result writing 812 depicted in the diagram 800, the packing check and control 902 may ensure that the hardware logic for the result writing 812 is more fully utilized.

The packing check and control 902 may perform operations for pixel E 908 and pixel F 910 and for pixel G 912 and pixel H 914 similar to those described above for the pixel A and pixel B hardware transactions 904 and the pixel C and pixel D hardware transaction 906. The packing check and control 902 may achieve more efficient hardware logic utilization and data path utilization for a texture pipeline in comparison to a texture pipeline without the packing check and control 902 (e.g., the texture pipeline depicted in the diagram 800).

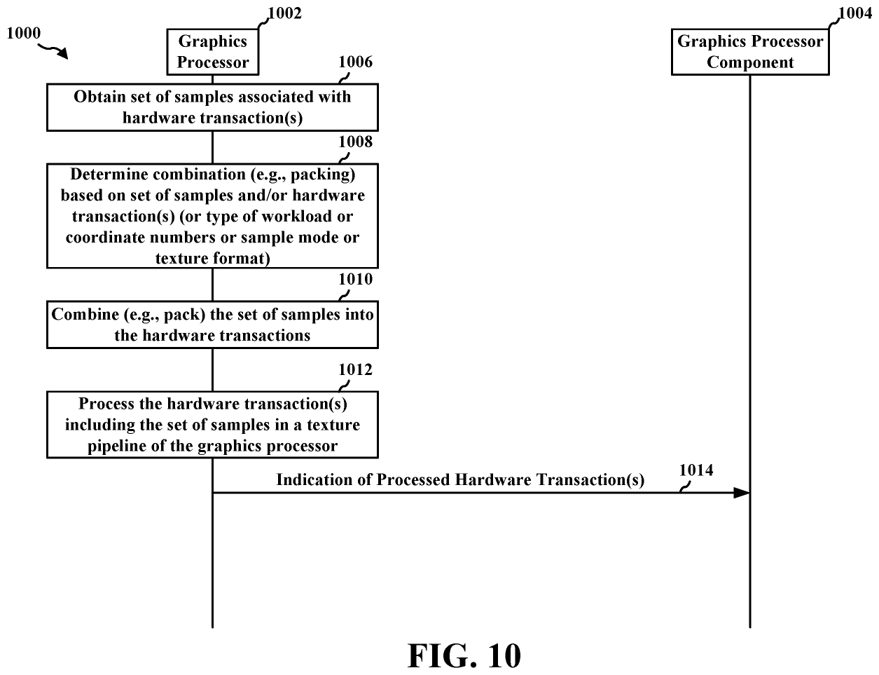

FIG. 10 is a call flow diagram 1000 illustrating example communications between a graphics processor 1002 and a graphics processor component 1004 in accordance with one or more techniques of this disclosure. In an example, the graphics processor 1002 may include the texture pipeline 726 and the graphics processor component 1004 may be the pixel shader 720 or a shader processor associated with the pixel shader 720.

At 1006, the graphics processor 1002 may obtain a set of samples associated with hardware transaction(s). In an example, the set of samples may be a set of coordinates, a set of texels, or a set of components associated with channels (e.g., a R component, a G component, a B component, and/or an A component). In an example, the hardware transaction(s) may include one or more of the hardware transactions 802. The set of samples may be associated with a first type of texture filtering and/or a first texture format and the hardware transaction(s) may be associated with a second type of texture filtering and/or a second type of texture format.

At 1008, the graphics processor 1002 may determine a combination (e.g., a packing) based on a type of workload associated with the set of samples and the hardware transaction(s). In one example, a texture front end packing of the graphics processor 1002 may determine the combination based on a coordinate number associated with the set of samples and a sample mode (e.g., 2 texel bilinear sampling, 4 texel bilinear sampling, 4 texel trilinear sampling, 8 texel trilinear sampling, anisotropic sampling, etc.) associated with the hardware transaction(s). In an example, a two dimensional coordinate may pack points of two pixels. In another example, a texture back end packing of the graphics processor 1002 may determine the combination based on the sample mode and a requested texture format (i.e., a requested number of components for a texture). In an example, a point sample for a packed first pixel may be issued to a R channel of a RGBA data path and a point sample for a packed second pixel may be issued to a G channel of the RGBA data path. In another example involving a two-component texture, a first pixel sample may use a R channel and a G channel and a second pixel sample may use a B channel and an A channel.

At 1010, the graphics processor 1002 may combine the set of samples into the hardware transactions. At 1012, the graphics processor 1002 may process, in a texture pipeline, the hardware transactions including the set of samples. In an example, the texture pipeline may be the texture pipeline 726. At 1014, the graphics processor 1002 may output an indication of the processed hardware transaction(s) including the set of samples to the graphics processor component 1004. For instance, the graphics processor 1002 may transmit the indication of the processed hardware transaction(s) including the set of samples to a shader processer associated with the pixel shader 720.

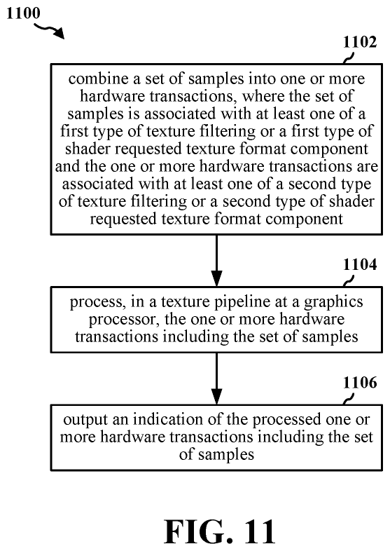

FIG. 11 is a flowchart 1100 of an example method of graphics processing in accordance with one or more techniques of this disclosure. The method may be performed by an apparatus, such as a GPU, an apparatus for graphics processing, a CPU, a wireless communication device, and the like, as used in connection with the aspects of FIGS. 1-10. In an example, the apparatus (e.g., a GPU) may be or include the device 104, the processing unit 120, or the GPU 200. The method may be associated with various technical advantages, such as more efficient hardware transaction loading, lower power consumption, etc. In an example, the method may be performed by the packer and checker 198.

At 1102, the apparatus (e.g., a GPU) combines a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component. For example, FIG. 10 at 1010 shows that the graphics processor 1002 may combine a set of samples into one or more hardware transactions. In an example, the set of samples may be or include the texel 402. In another example, the one or more hardware transactions may be or include the hardware transactions 802. In a further example, the set of samples may be associated with the hardware transactions 802. In another example, the first type of texture filtering and/or the second type of texture filtering may be or include point filtering depicted in the first example 502, bilinear filtering depicted in the second example 514, trilinear filtering depicted in the third example 602, or another type of filtering. In an example, the first type of shader requested texture format component and/or the second type of shader requested texture format component may include aspects described above in connection with FIG. 4. In a further example, FIG. 9 shows that for the SRC loading associated with the pixel A and pixel B hardware transactions 904, coordinates associated with pixel A 816 may be loaded into hardware logic for C0 and hardware logic for C1 and coordinates associated with pixel B 820 may be loaded into hardware logic for C2 and hardware logic for C3. In another example, FIG. 9 shows that for the cache reading associated with the pixel A and pixel B hardware transactions 904, a texel sample associated with pixel A 816 may be loaded into hardware logic for T0 and a texel sample associated with pixel B 820 may be loaded into hardware logic for T1. In yet another example, FIG. 9 shows that for the filtering associated with the pixel A and pixel B hardware transactions 904, a R component associated with pixel A 816 may be loaded into hardware logic for a R channel, a G component associated with pixel A 816 may be loaded into hardware logic for a G channel, a R component associated with pixel B 820 may be loaded into hardware logic for a B channel, and a G component associated with pixel B 820 may be loaded into hardware logic for an A channel. In an example, 1102 may be performed by the packer and checker 198.

At 1104, the apparatus (e.g., a GPU) processes, in a texture pipeline at a graphics processor, the one or more hardware transactions including the set of samples. For example, FIG. 10 at 1012 shows that the graphics processor 1002 may process hardware transaction(s) including a set of samples in a texture pipeline of the graphics processor 1002. In an example, the texture pipeline may be or include the graphics processing pipeline 107 and/or the texture pipeline 726. In an example, the graphics processor may be the GPU 200. In an example, processing the one or more hardware transactions including the set of samples may include executing the hardware transactions 802 as depicted in FIG. 9. For instance, processing the one or more hardware transactions including the set of samples may include executing one or more of the pixel A and pixel B hardware transactions 904. In an example, 1104 may be performed by the packer and checker 198.

At 1106, the apparatus (e.g., a GPU) outputs an indication of the processed one or more hardware transactions including the set of samples. For example, FIG. 10 at 1014 shows that the graphics processor 1002 may output an indication of processed hardware transaction(s), where the processed hardware transaction(s) may include the set of samples. In an example, 1106 may be performed by the packer and checker 198.

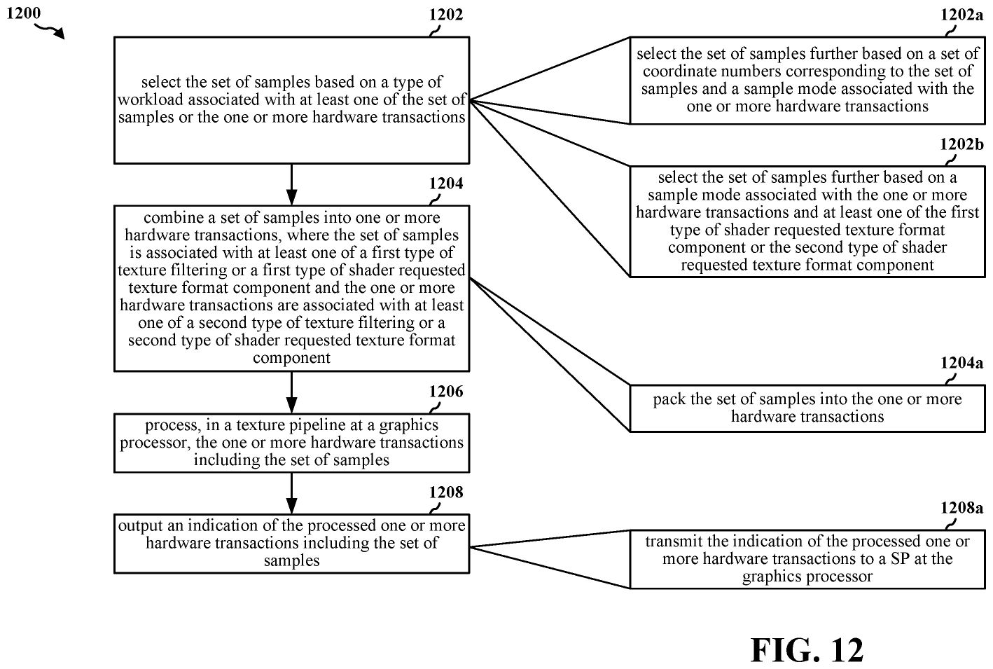

FIG. 12 is a flowchart 1200 of an example method of graphics processing in accordance with one or more techniques of this disclosure. The method may be performed by an apparatus, such as a GPU, an apparatus for graphics processing, a CPU, a wireless communication device, and the like, as used in connection with the aspects of FIGS. 1-10. In an example, the apparatus (e.g., a GPU) may be or include the device 104, the processing unit 120, or the GPU 200. The method may be associated with various technical advantages, such as more efficient hardware transaction loading, lower power consumption, etc. In an example, the method (including the various aspects detailed below) may be performed by the packer and checker 198.

At 1204, the apparatus (e.g., a GPU) combines a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component. For example, FIG. 10 at 1010 shows that the graphics processor 1002 may combine a set of samples into one or more hardware transactions. In an example, the set of samples may be or include the texel 402. In another example, the one or more hardware transactions may be or include the hardware transaction 802. In a further example, the set of samples may be associated with the hardware transactions 802. In another example, the first type of texture filtering and/or the second type of texture filtering may be or include point filtering depicted in the first example 502, bilinear filtering depicted in the second example 514, trilinear filtering depicted in the third example 602, or another type of filtering. In an example, the first type of shader requested texture format component and/or the second type of shader requested texture format component may include aspects described above in connection with FIG. 4. In a further example, FIG. 9 shows that for the SRC loading associated with the pixel A and pixel B hardware transactions 904, coordinates associated with pixel A 816 may be loaded into hardware logic for C0 and hardware logic for C1 and coordinates associated with pixel B 820 may be loaded into hardware logic for C2 and hardware logic for C3. In another example, FIG. 9 shows that for the cache reading associated with the pixel A and pixel B hardware transactions 904, a texel sample associated with pixel A 816 may be loaded into hardware logic for T0 and a texel sample associated with pixel B 820 may be loaded into hardware logic for T1. In yet another example, FIG. 9 shows that for the filtering associated with the pixel A and pixel B hardware transactions 904, a R component associated with pixel A 816 may be loaded into hardware logic for a R channel, a G component associated with pixel A 816 may be loaded into hardware logic for a G channel, a R component associated with pixel B 820 may be loaded into hardware logic for a B channel, and a G component associated with pixel B 820 may be loaded into hardware logic for an A channel. In an example, 1204 may be performed by the packer and checker 198.

At 1206, the apparatus (e.g., a GPU) processes, in a texture pipeline at a graphics processor, the one or more hardware transactions including the set of samples. For example, FIG. 10 at 1012 shows that the graphics processor 1002 may process hardware transaction(s) including a set of samples in a texture pipeline of the graphics processor 1002. In an example, the texture pipeline may be or include the graphics processing pipeline 107 and/or the texture pipeline 726. In an example, the graphics processor may be the GPU 200. In an example, processing the one or more hardware transactions including the set of samples may include executing the hardware transactions 802 as depicted in FIG. 9. For instance, processing the one or more hardware transactions including the set of samples may include executing one or more of the pixel A and pixel B hardware transactions 904. In an example, 1206 may be performed by the packer and checker 198.

At 1208, the apparatus (e.g., a GPU) outputs an indication of the processed one or more hardware transactions including the set of samples. For example, FIG. 10 at 1014 shows that the graphics processor 1002 may output an indication of processed hardware transaction(s), where the processed hardware transaction(s) may include the set of samples. In an example, 1208 may be performed by the packer and checker 198.

In one aspect, at 1202, the apparatus (e.g., a GPU) may select the set of samples based on a type of workload associated with at least one of the set of samples or the one or more hardware transactions. For example, FIG. 10 at 1008 shows that the graphics processor 1002 may determine a combination of a set of samples (i.e., select a set of samples that are to be combined) prior to combining the set of samples into the hardware transactions at 1010. Furthermore, FIG. 10 at 1008 shows that the combination may be based on a type of workload associated with the set of samples and/or the hardware transactions. In an example, 1202 may be performed by the packer and checker 198.

In one aspect, at 1202a, selecting the set of samples may be further based on a set of coordinate numbers corresponding to the set of samples and a sample mode associated with the one or more hardware transactions. For example, FIG. 10 at 1008 shows that the graphics processor 1002 may determine (i.e., select) the combination based on coordinate numbers and a sample mode. In an example, the sample mode may correspond to sampling performed as part of the point filtering depicted in the first example 502, the bilinear filtering depicted in the second example 514, the trilinear filtering depicted in the third example 602, or another type of filtering. In another example, the set of coordinate numbers may be associated with the hardware logic for C0, C1, C2, and/or C3 illustrated in FIG. 9. In an example, 1202a may be performed by the packer and checker 198.

In one aspect, at 1202b, selecting the set of samples may be further based on a sample mode associated with the one or more hardware transactions and at least one of the first type of shader requested texture format component or the second type of shader requested texture format component. For example, FIG. 10 at 1008 shows that the graphics processor 1002 may determine (i.e., select) the combination based on a sample mode and a texture format. In an example, the sample mode may correspond to sampling performed as part of the point filtering depicted in the first example 502, the bilinear filtering depicted in the second example 514, the trilinear filtering depicted in the third example 602, or another type of filtering. In an example, the first type of shader requested texture format component and/or the second type of shader requested texture format component may include aspects described above in connection with FIG. 4. For instance, the first type of shader requested texture format component may be associated with RG 408 and the second type of shader requested texture format component may be associated with RGBA 412. In an example, 1202b may be performed by the packer and checker 198.

In one aspect, the first type of texture filtering may include nearest neighbor point filtering, and the second type of texture filtering may include bilinear filtering. For example, the nearest neighbor point filtering may be the point filtering depicted in the first example 502 and the bilinear filtering may be the bilinear filtering depicted in the second example 514.

In one aspect, the first type of shader requested texture format component may include a single component texture, and the second type of shader requested texture format component may include a four component texture. For example, the single component texture may be a texture that includes R 406 and the four component texture may be a texture that includes RGBA 412.

In one aspect, the four component texture may include a red component, a green component, a blue component, and an alpha component. For example, the four component texture may be a texture that includes RGBA 412.

In one aspect, at 1204a, combining the set of samples into the one or more hardware transactions may include: packing the set of samples into the one or more hardware transactions. For example, FIG. 10 at 1010 shows that the graphics processor 1002 may pack a set of samples into hardware transactions. In another example, packing the set of samples into the one or more hardware transactions may include aspects described above in relation to FIG. 9. In an example, 1204a may be performed by the packer and checker 198.

In one aspect, the set of samples may be associated with a set of pixels or a set of texels. For example, the set of samples may be associated with pixel A 816 and pixel B 820 as described above in FIG. 9. In another example, the set of samples may be associated with pixel C 822 and pixel D 824. In a further example, the set of samples may be associated with pixel E 908 and pixel F 910. In a further example, the set of samples may be associated with pixel G 912 and pixel H 914. In an example, the set of texels may be or include the texel 402. In a further example, the set of texels may be associated with the addressing 806, the cache reading 808, and/or the filtering 810 as described above in relation to FIG. 9.

In one aspect, the set of samples may be associated with the set of pixels, and the set of samples may include a first subset of samples associated with a first pixel in the set of pixels and a second subset of samples associated with a second pixel in the set of pixels. In an example, the first pixel may be pixel A 816 and the second pixel may be pixel B 820. In another example, the first pixel may be pixel C 822 and the second pixel may be pixel D 824. In a further example, the first subset of samples may be “Pixel A Associated” and the second subset of samples may be “Pixel B Associated” as illustrated in FIG. 9. In another example, the first subset of samples may be “Pixel C Associated” and the second subset of samples may be “Pixel D Associated” as illustrated in FIG. 9.

In one aspect, the set of samples may be a set of texture samples or a set of surface loading samples. For example, the set of samples may be associated with the SRC loading 804. In another example, the set of samples may be associated with the addressing 806, the cache reading 808, and/or the filtering 810.

In one aspect, the set of texture samples may include a first texture sample and a second texture sample, and combining the set of samples into the one or more hardware transactions may include combining the first texture sample and the second texture sample into the one or more hardware transactions. For example, FIG. 9 shows that a first texture sample associated with pixel A 816 and a second texture sample associated with pixel B may be combined into the addressing 806, the cache reading 808, and/or the filtering 810.

In one aspect, the one or more hardware transactions may include a single hardware transaction at the graphics processor or a set of hardware transactions at the graphics processor. For example, the single hardware transaction may be the SRC loading 804, the addressing 806, the cache reading 808, the filtering 810, or the result writing 812. In another example, the set of hardware transactions may include the hardware transactions 802.

In one aspect, the set of hardware transactions at the graphics processor may include at least one of: a SRC loading transaction, an SRC texture sample parameter transaction, an addressing transaction, a cache reading transaction, a filtering transaction, or a result writing transaction. For example, the set of hardware transactions may include the SRC loading 804 (e.g., a SRC texture sample parameter transaction), the addressing 806, the cache reading 808, the filtering 810, and/or the result writing 812.

In one aspect, at 1208a, outputting the indication of the processed one or more hardware transactions may include: transmitting the indication of the processed one or more hardware transactions to a SP at the graphics processor. For example, FIG. 10 at 1014 shows that the graphics processor 1002 may transmit an indication of processed hardware transaction(s) to the graphics processor component 1004, where the graphics processor component 1004 may be a SP. In another example, the SP may be associated with the pixel shader 720. In an example, 1208a may be performed by the packer and checker 198.

In one aspect, the first type of shader requested texture format component and the second type of shader requested texture format component may be a same shader requested texture format component. For example, the first type of shader requested texture format component and the second type of shader requested texture format component may be the same.

In one aspect, the first type of shader requested texture format component may be different from the second type of shader requested texture format component. For example, the first type of shader requested texture format component may be a texture format that supports RG 408 and the second type of shader requested texture format component may be a texture format that supports RGBA 412.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for combining a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component. The apparatus may further include means for processing, in a texture pipeline at a graphics processor, the one or more hardware transactions including the set of samples. The apparatus may further include means for outputting an indication of the processed one or more hardware transactions including the set of samples. The apparatus may further include means for selecting the set of samples based on a type of workload associated with at least one of the set of samples or the one or more hardware transactions. The means for outputting the indication may include means for transmitting the indication of the processed one or more hardware transactions to a SP at the graphics processor. The means for combining the set of samples into the one or more hardware transactions may include means for packing the set of samples into the one or more hardware transactions.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may comprise RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including combining a set of samples into one or more hardware transactions, where the set of samples is associated with at least one of a first type of texture filtering or a first type of shader requested texture format component and the one or more hardware transactions are associated with at least one of a second type of texture filtering or a second type of shader requested texture format component; processing, in a texture pipeline at a graphics processor, the one or more hardware transactions including the set of samples; and outputting an indication of the processed one or more hardware transactions including the set of samples.

Aspect 2 may be combined with aspect 1 and further includes that selecting the set of samples based on a type of workload associated with at least one of the set of samples or the one or more hardware transactions.

Aspect 3 may be combined with aspect 2 and includes that selecting the set of samples is further based on a set of coordinate numbers corresponding to the set of samples and a sample mode associated with the one or more hardware transactions.

Aspect 4 may be combined with aspect 2 and includes that selecting the set of samples is further based on a sample mode associated with the one or more hardware transactions and at least one of the first type of shader requested texture format component or the second type of shader requested texture format component.

Aspect 5 may be combined with any of aspects 1-4 and includes that the first type of texture filtering includes nearest neighbor point filtering, and where the second type of texture filtering includes bilinear filtering.

Aspect 6 may be combined with any of aspects 1-5 and includes that the first type of shader requested texture format component includes a single component texture, and where the second type of shader requested texture format component includes a four component texture.

Aspect 7 may be combined with aspect 6 and includes that the four component texture includes a red component, a green component, a blue component, and an alpha component.

Aspect 8 may be combined with any of aspects 1-7 and includes that combining the set of samples into the one or more hardware transactions includes: packing the set of samples into the one or more hardware transactions.

Aspect 9 may be combined with any of aspects 1-8 and includes that the set of samples is associated with a set of pixels or a set of texels.

Aspect 10 may be combined with aspect 9 and includes that the set of samples is associated with the set of pixels, and where the set of samples includes a first subset of samples associated with a first pixel in the set of pixels and a second subset of samples associated with a second pixel in the set of pixels.

Aspect 11 may be combined with any of aspects 1-10 and includes that the set of samples is a set of texture samples or a set of surface loading samples.

Aspect 12 may be combined with aspect 11 and includes that the set of texture samples includes a first texture sample and a second texture sample, where combining the set of samples into the one or more hardware transactions includes combining the first texture sample and the second texture sample into the one or more hardware transactions.

Aspect 13 may be combined with any of aspects 1-12 and includes that the one or more hardware transactions include a single hardware transaction at the graphics processor or a set of hardware transactions at the graphics processor.

Aspect 14 may be combined with aspect 13 and includes that the set of hardware transactions at the graphics processor includes at least one of: a SRC loading transaction, an SRC texture sample parameter transaction, an addressing transaction, a cache reading transaction, a filtering transaction, or a result writing transaction.

Aspect 15 may be combined with any of aspects 1-14 and includes that outputting the indication of the processed one or more hardware transactions includes: transmitting the indication of the processed one or more hardware transactions to a SP at the graphics processor.

Aspect 16 may be combined with any of aspects 1-15 and includes that the first type of shader requested texture format component and the second type of shader requested texture format component are a same shader requested texture format component.

Aspect 17 may be combined with any of aspects 1-15 and includes that the first type of shader requested texture format component is different from the second type of shader requested texture format component.

Aspect 18 is an apparatus for graphics processing including at least one processor coupled to a memory and configured to implement a method as in any of aspects 1-17.

Aspect 19 may be combined with aspect 18 and includes that the apparatus is a wireless communication device including at least one of an antenna or a transceiver coupled to the at least one processor, and where the at least one processor is configured to obtain the set of samples via at least one of the antenna or the transceiver.

Aspect 20 is an apparatus for graphics processing including means for implementing a method as in any of aspects 1-17.

Aspect 21 is a computer-readable medium (e.g., a non-transitory computer-readable medium) storing computer executable code, the computer executable code when executed by at least one processor causes the at least one processor to implement a method as in any of aspects 1-17.

Various aspects have been described herein. These and other aspects are within the scope of the following claims.

What is claimed is:

1. An apparatus for graphics processing, comprising:
a memory; and
at least one processor coupled to the memory and, based at least in part on information stored in the memory, the at least one processor is configured to:
combine a set of samples into one or more hardware transactions, wherein the set of samples is associated with at least one of a first type of texture filtering or a first type of shader requested texture format component and the one or more hardware transactions are associated with at least one of a second type of texture filtering or a second type of shader requested texture format component;
process, in a texture pipeline at a graphics processor, the one or more hardware transactions including the set of samples; and
output an indication of the processed one or more hardware transactions including the set of samples.

2. The apparatus of claim 1, wherein the at least one processor is further configured to:
select the set of samples based on a type of workload associated with at least one of the set of samples or the one or more hardware transactions.

3. The apparatus of claim 2, wherein to select the set of samples, the at least one processor is configured to select the set of samples further based on a set of coordinate numbers corresponding to the set of samples and a sample mode associated with the one or more hardware transactions.

4. The apparatus of claim 2, wherein to select the set of samples, the at least one processor is configured to select the set of samples further based on a sample mode associated with the one or more hardware transactions and at least one of the first type of shader requested texture format component or the second type of shader requested texture format component.

5. The apparatus of claim 1, wherein the first type of texture filtering comprises nearest neighbor point filtering, and wherein the second type of texture filtering comprises bilinear filtering.

6. The apparatus of claim 1, wherein the first type of shader requested texture format component comprises a single component texture, and wherein the second type of shader requested texture format component comprises a four component texture.

7. The apparatus of claim 6, wherein the four component texture comprises a red component, a green component, a blue component, and an alpha component.

8. The apparatus of claim 1, wherein to combine the set of samples into the one or more hardware transactions, the at least one processor is configured to pack the set of samples into the one or more hardware transactions.

9. The apparatus of claim 1, wherein the set of samples is associated with a set of pixels or a set of texels.

10. The apparatus of claim 9, wherein the set of samples is associated with the set of pixels, and wherein the set of samples includes a first subset of samples associated with a first pixel in the set of pixels and a second subset of samples associated with a second pixel in the set of pixels.

11. The apparatus of claim 1, wherein the set of samples is a set of texture samples or a set of surface loading samples.

12. The apparatus of claim 11, wherein the set of texture samples includes a first texture sample and a second texture sample, wherein to combine the set of samples into the one or more hardware transactions, the at least one processor is configured to combine the first texture sample and the second texture sample into the one or more hardware transactions.

13. The apparatus of claim 1, wherein the one or more hardware transactions include a single hardware transaction at the graphics processor or a set of hardware transactions at the graphics processor.

14. The apparatus of claim 13, wherein the set of hardware transactions at the graphics processor includes at least one of: a source (SRC) loading transaction, a SRC texture sample parameter transaction, an addressing transaction, a cache reading transaction, a filtering transaction, or a result writing transaction.

15. The apparatus of claim 1, wherein to output the indication of the processed one or more hardware transactions, the at least one processor is configured to transmit the indication of the processed one or more hardware transactions to a shader processor (SP) at the graphics processor.

16. The apparatus of claim 1, wherein the first type of shader requested texture format component and the second type of shader requested texture format component are a same shader requested texture format component.

17. The apparatus of claim 1, wherein the first type of shader requested texture format component is different from the second type of shader requested texture format component.

18. The apparatus of claim 1, wherein the apparatus is a wireless communication device comprising at least one of an antenna or a transceiver coupled to the at least one processor, and wherein to obtain the set of samples, the at least one processor is configured to obtain the set of samples via at least one of the antenna or the transceiver.

19. A method of graphics processing, comprising:
combining a set of samples into one or more hardware transactions, wherein the set of samples is associated with at least one of a first type of texture filtering or a first type of shader requested texture format component and the one or more hardware transactions are associated with at least one of a second type of texture filtering or a second type of shader requested texture format component;
processing, in a texture pipeline at a graphics processor, the one or more hardware transactions including the set of samples; and
outputting an indication of the processed one or more hardware transactions including the set of samples.

20. The method of claim 19, further comprising:
selecting the set of samples based on a type of workload associated with at least one of the set of samples or the one or more hardware transactions.

21. The method of claim 20, wherein selecting the set of samples is further based on a set of coordinate numbers corresponding to the set of samples and a sample mode associated with the one or more hardware transactions.

22. The method of claim 20, wherein selecting the set of samples is further based on a sample mode associated with the one or more hardware transactions and at least one of the first type of shader requested texture format component or the second type of shader requested texture format component.

23. The method of claim 19, wherein the first type of texture filtering comprises nearest neighbor point filtering, and wherein the second type of texture filtering comprises bilinear filtering.

24. The method of claim 19, wherein the first type of shader requested texture format component comprises a single component texture, and wherein the second type of shader requested texture format component comprises a four component texture.

25. The method of claim 24, wherein the four component texture comprises a red component, a green component, a blue component, and an alpha component.

26. The method of claim 19, wherein combining the set of samples into the one or more hardware transactions comprises: packing the set of samples into the one or more hardware transactions.

27. The method of claim 19, wherein the set of samples is associated with a set of pixels or a set of texels.

28. The method of claim 27, wherein the set of samples is associated with the set of pixels, and wherein the set of samples includes a first subset of samples associated with a first pixel in the set of pixels and a second subset of samples associated with a second pixel in the set of pixels.

29. The method of claim 19, wherein the set of samples is a set of texture samples or a set of surface loading samples.

30. A computer-readable medium storing computer executable code, the computer executable code when executed by at least one processor causes the at least one processor to:
combine a set of samples into one or more hardware transactions, wherein the set of samples is associated with at least one of a first type of texture filtering or a first type of shader requested texture format component and the one or more hardware transactions are associated with at least one of a second type of texture filtering or a second type of shader requested texture format component;
process, in a texture pipeline at a graphics processor, the one or more hardware transactions including the set of samples; and
output an indication of the processed one or more hardware transactions including the set of samples.
